(19) United States
(12) Patent Application Publication
(10) Pub. No.: US 2026/0279228 A1
(43) Pub. Date: Sep. 17, 2026

(54) ELECTRONIC SHELF LABEL HOLDER

(71) Applicant: Fasteners for Retail, Inc., Twinsburg, OH (US)

(72) Inventors: David A. Schultz, Walworth, WI (US); Alex Souhala, Rockford, IL (US); Justin Joshua Campbell, Pecatonica, IL (US)

(73) Assignee: Fasteners for Retail, Inc., Twinsburg, OH (US)

(21) Appl. No.: 19/679,024

(22) Filed: May 15, 2026

Related U.S. Application Data
(63) Continuation of application No. 18/607,300, filed on Mar. 15, 2024.
Application No. 18/607,300 is a continuation-in-part of application No. 29/912,312, filed on Sep. 15, 2023, now Pat. No. D1109806.

(51) Int. Cl. G09F 3/20

(52) U.S. Cl. CPC G09F 3/208; G09F 3/204

(57) ABSTRACT

An attachment system includes a rear wall including a front side and a rear side formed on an opposite side from the front side, and a base wall extending from the front side of the rear wall to a front edge and including a top side and a bottom side formed on an opposite side from the top side. The attachment system also includes a lower retaining lip disposed on the base wall and spaced apart from the front side to define a first channel extending along the top side of the base wall, a release tab extending from the base wall, and an upper retaining lip extending from the rear wall and spaced apart from the top side of the base wall to define a second channel extending along the front side of the rear wall.

### CROSS REFERENCE TO RELATED APPLICATIONS

This application is a continuation of, and claims priority under 35 U.S.C. § 120 from, U.S. patent application Ser. No. 18/607,300, filed on Mar. 15, 2024, which is a continuation-in-part of, and claims priority under 35 U.S.C. § 120 from, U.S. patent application Ser. No. 29/912,312, filed on Sep. 15, 2023. The disclosures of these prior application are considered part of the disclosure of this application and are hereby incorporated by reference in its entirety.

### FIELD

The present disclosure relates generally to an electronic shelf label holder for merchandise display systems.

### BACKGROUND

This section provides background information related to the present disclosure and is not necessarily prior art.

In self-service retail establishments, such as drug stores, grocery stores and the like, articles are usually displayed for sale on racks consisting of vertically spaced shelves on which the articles are arranged in rows. Due to frequent stock changes, systems to easily add or remove labels to an existing product rail would greatly improve the ease of use.

### SUMMARY

One aspect of the disclosure provides an electronic shelf label holder system for securing a display device to a retail shelf. The system includes a rear wall including a front side and a rear side formed on an opposite side from the front side, and a base wall extending from the front side of the rear wall to a front edge and including a top side and a bottom side formed on an opposite side from the top side. The system also includes a lower retaining lip disposed on the top side of the base wall and spaced apart from the front side to define a first channel extending along the top side of the base wall, a release tab extending from the bottom side of the base wall adjacent to the front edge of the base wall, and an upper retaining lip extending from the front side of the rear wall and spaced apart from the top side of the base wall to define a second channel extending along the front side of the rear wall.

Implementations of the disclosure may include one or more of the following optional features. In some examples, the first channel and the second channel cooperate to define a receptacle configured to receive the display device. In some implementations, the system further includes a mounting member attached to the rear side of the rear wall. In these implementations, the mounting member may be configured to attach the rear wall of the attachment system to the retail shelf at a vertical angle. Alternatively, the mounting member may be configured to attach the rear wall of the attachment system to the retail shelf at an oblique angle.

In some examples, the release tab extends from the bottom side of the base wall at an acute angle relative to the bottom side. In some implementations, the release tab is spaced apart from the front of the base wall. In some examples, the release tab extends from a front portion of the base wall. In some implementations, the base wall is perpendicular to the rear wall.

In some examples, the upper retaining lip extends towards the base wall at an oblique angle from the rear wall. In some implementations, the lower retaining lip includes a front wall extending from the top side of the base wall and a rear flange extending from the front wall towards the rear wall. In these implementations, the rear flange may be spaced apart from the top side of the base wall to define a socket between the lower retaining lip and the base wall.

Another aspect of the disclosure provides an electronic shelf label holder system for securing a display device to a retail shelf. The system includes a rear wall including a front side and a rear side formed on an opposite side from the front side, and a base wall extending from the front side of the rear wall to a front edge and including a top side and a bottom side formed on an opposite side from the top side. The system also includes a lower retaining lip disposed on the top side of the base wall and spaced apart from the front side of the rear wall to define a first channel extending along the top side of the base wall, a release tab extending from the bottom side of the base wall and spaced apart from the front edge of the base wall, and an upper retaining lip extending from the front side of the rear wall.

Implementations of the disclosure may include one or more of the following optional features. In some examples, the upper retaining lip is spaced apart from the top side of the base wall to define a second channel extending along the front side of the rear wall. In these examples, wherein the first channel and the second channel may cooperate to define a receptacle configured to receive the display device. In some implementations, the system further includes a mounting member attached to the rear side of the rear wall. In these implementations, the mounting member may be configured to attach the rear wall of the attachment system to the retail shelf at a vertical angle. Alternatively, the mounting member may be configured to attach the rear wall of the attachment system to the retail shelf at an oblique angle.

In some examples, the release tab extends from the bottom side of the base wall at an acute angle relative to the bottom side. In some implementations, the release tab extends from a front portion of the base wall. In some examples, the base wall is perpendicular to the rear wall.

In some implementations, the upper retaining lip extends towards the base wall at an oblique angle from the rear wall. In some examples, the lower retaining lip includes a front wall extending from the top side of the base wall and a rear flange extending from the front wall towards the rear wall. In these examples, the rear flange may be spaced apart from the top side of the base wall to define a socket between the lower retaining lip and the base wall.

This section provides a general summary of the disclosure, and is not a comprehensive disclosure of its full scope or all of its features.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a perspective view of an electronic shelf label holder according to an example of the present disclosure;

FIG. 2 is a front elevation view of the electronic shelf label holder of FIG. 1;

FIG. 3 is a back elevation view of the electronic shelf label holder of FIG. 1;

FIG. 4A is a left end elevation view of the electronic shelf label holder of FIG. 1;

FIG. 4B is a right end elevation view of the electronic shelf label holder of FIG. 1;

FIG. 5 is a top plan view of the electronic shelf label holder of FIG. 1;

FIG. 6 is a bottom plan view of the electronic shelf label holder of FIG. 1;

FIG. 7 is a perspective view of an electronic shelf label holder according to an example of the present disclosure;

FIG. 8 is a front elevation view of the electronic shelf label holder of FIG. 7;

FIG. 9 is a back elevation view of the electronic shelf label holder of FIG. 7;

FIG. 10A is right end elevation view of the electronic shelf label holder of FIG. 7;

FIG. 10B is a left end elevation view of the electronic shelf label holder of FIG. 7;

FIG. 11 is a top plan view of the electronic shelf label holder of FIG. 7;

FIG. 12 is a bottom plan view of the electronic shelf label holder of FIG. 7;

FIG. 13 is a perspective view of an electronic shelf label holder according to an example of the present disclosure;

FIG. 14 is a front elevation view of the electronic shelf label holder of FIG. 13;

FIG. 15 is a back elevation view of the electronic shelf label holder of FIG. 13;

FIG. 16A is a right end elevation view of the electronic shelf label holder of FIG. 13;

FIG. 16B is a left end elevation view of the electronic shelf label holder of FIG. 13;

FIG. 17 is a top plan view of the electronic shelf label holder of FIG. 13; and

FIG. 18 is a bottom plan view of the electronic shelf label holder of FIG. 13.

### Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

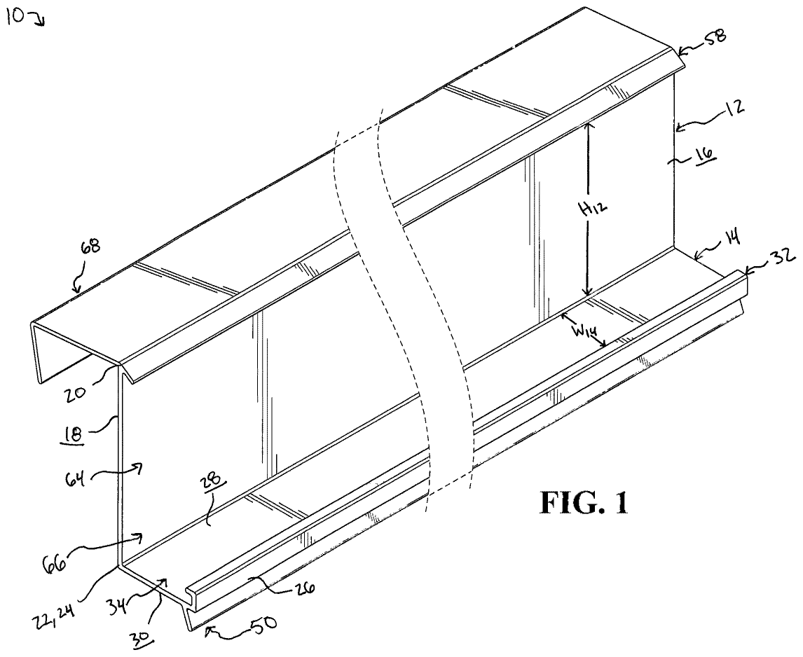

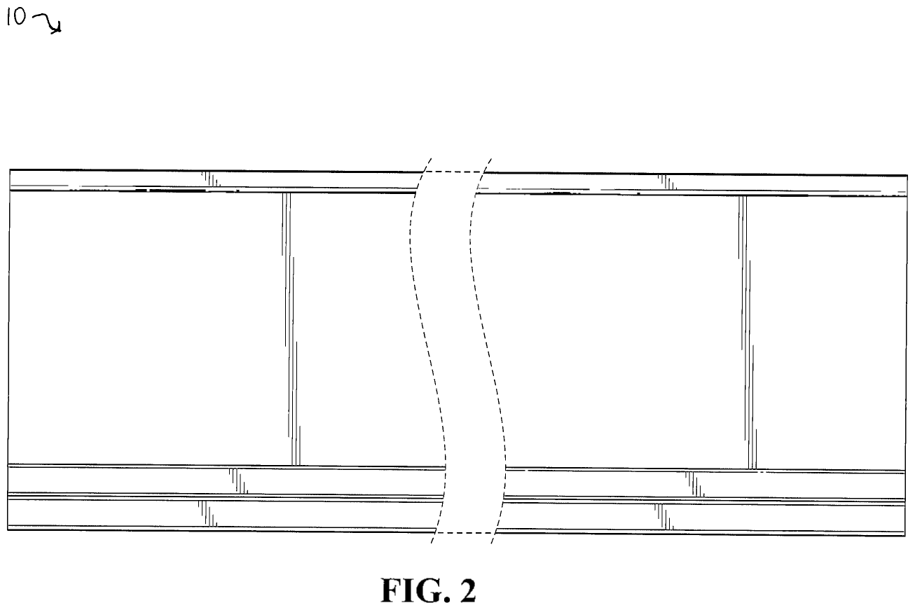

Referring to FIGS. 1 and 2, an attachment system 10 for securing a display device (not shown) to a retail shelf is generally shown. The attachment system 10 may be formed of a known suitable plastic, such as a thermoplastic extrusion, or metal, such as an aluminum extrusion and may be installed on a front surface (i.e., a front edge) of a shelf, or other suitable base surface for displaying the display device. The shelf may be located in a store or other suitable location where consumers are able to purchase merchandise. The shelf may generally be described as having a shelf body extending from a front edge to an opposite rear edge and along a plane that is generally parallel to a ground surface G, where the front edge and the opposite rear edge each extend perpendicular to the shelf body (i.e., perpendicular to the ground surface G) and between an upper end and a lower end, where the shelf body may generally be disposed between the respective upper end and the lower end of the front edge and the rear edge. As discussed throughout, the direction from the front edge to the rear edge defines a longitudinal direction while the direction parallel to the front edge and the rear edge defines a lateral direction, and the direction from the upper end to the lower end defines a transverse direction. In some implementations, the shelf may include apertures extending through a thickness of the shelf and arranged in series adjacent to each of the front edge and the rear edge of the shelf. Portions of the attachment system 10 may be secured to the shelf via fasteners engaging with the apertures. Additionally or alternatively, the attachment system 10 may be secured to the shelf in any suitable manner, and the attachment system 10 may be selectively detached from the shelf and moved, for example, to another shelf or other surface.

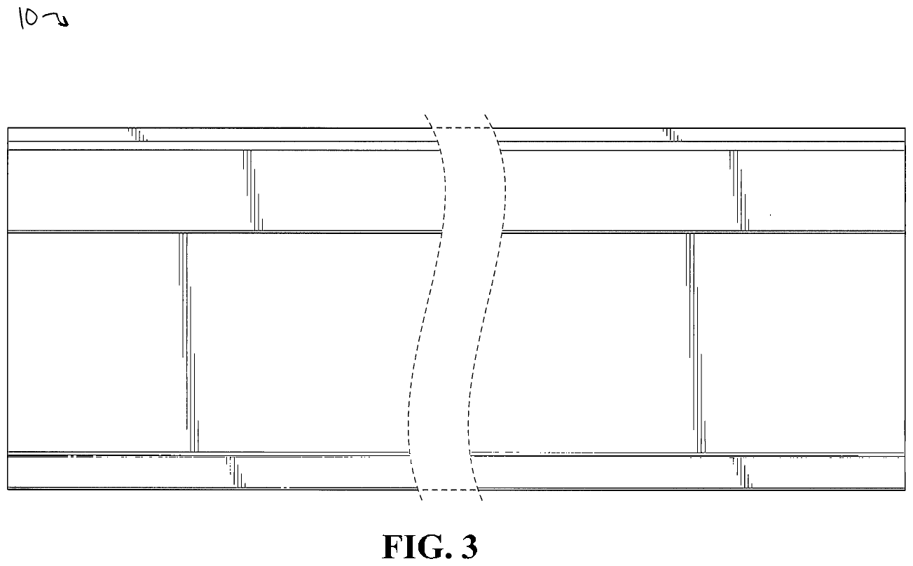

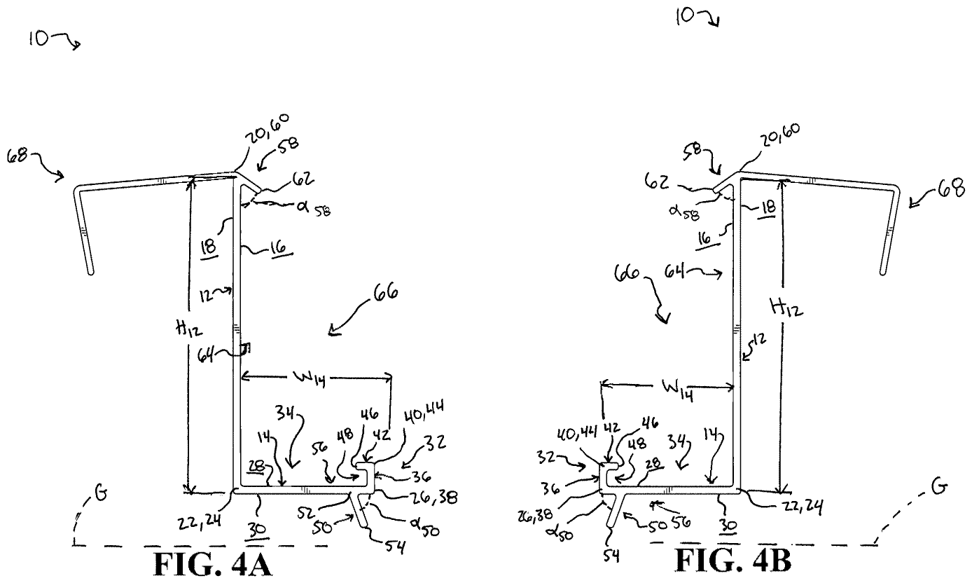

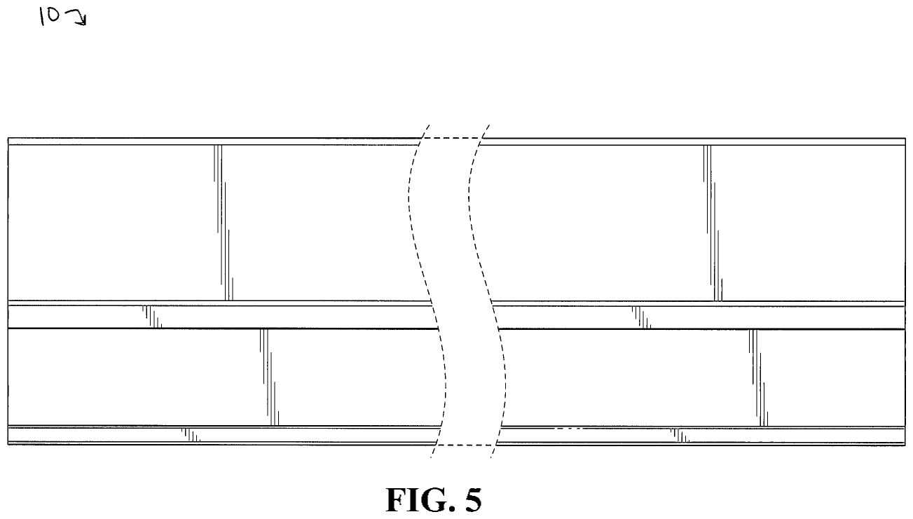

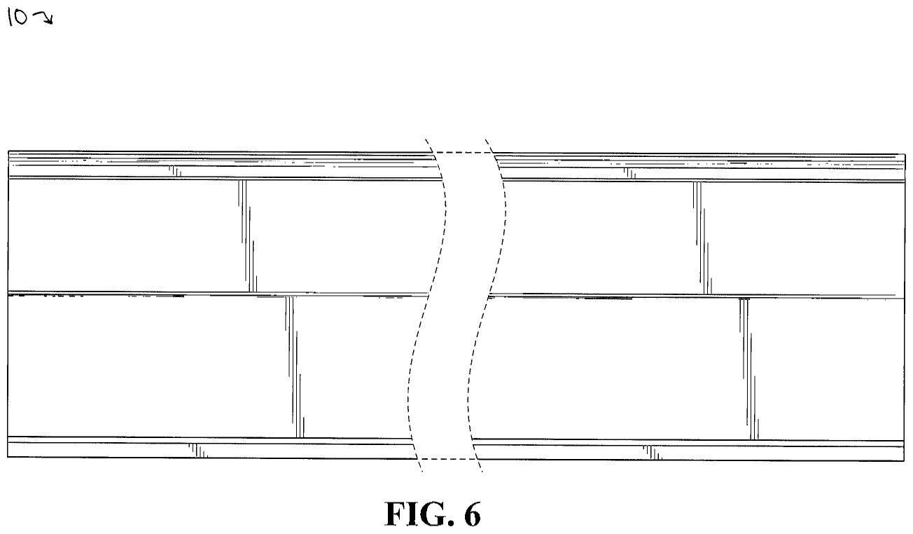

With reference to FIGS. 1-6, the attachment system 10 includes a rear wall 12 and a base wall 14 extending from the rear wall 12. In particular, the rear wall 12 includes a front side 16 and a rear side 18 formed on an opposite side of the rear wall 12 than the front side 16. The rear wall 12 may further be defined as extending from an upper end 20 to a lower end 22 disposed on an opposite end of the rear wall 12 than the upper end 20. As best shown in FIGS. 4A and 4B, the base wall 14 generally extends normal (i.e., perpendicular) to the rear wall 12 and from a first end 24 disposed at the front side 16 of the rear wall 12 to a second, front edge 26. The base wall 14 includes a top side 28 and a bottom side 30 formed on an opposite side of the base wall 14 from the top side 28.

With continued reference to FIGS. 1, 4A, and 4B, the attachment system 10 further includes a lower retaining lip 32 disposed on the top side 28 of the base wall 14 and spaced apart from the front side 16 of the rear wall 12 to define a first channel 34 extending along the top side 28 of the base wall 14. As shown, the first channel 34 generally extends across a width W14 of the base wall 14 between the front side 16 of the rear wall 12 and the lower retaining lip 32 disposed on the top side 28 of the base wall 14. In some implementations, the first channel 34 extends continuously and uninterrupted from the front side 16 of the rear wall 12 to the lower retaining lip 32. Optionally, the first channel 34 extends continuously from the front side 16 of the rear wall 12 to the front edge 26 of the base wall 14.

The lower retaining lip 32 includes a front wall 36 extending from a first end 38 disposed at the top side 28 of the base wall 14 to a second end 40 spaced away from the top side 28 of the base wall 14. As shown, the front wall 36 extends transverse (i.e., normal or slanted) relative to the top side 28 of the base wall 14, and extends parallel to the rear wall 12. In some implementations, the front wall 36 aligns with and corresponds to the front edge 26 of the base wall 14. However, in other implementations, the front wall 36 may be inwardly offset from the front edge 26 of the base wall 14. The lower retaining lip 32 further includes a rear flange 42 extending from a first end 44 disposed at the second end 40 of the front wall 36 towards the rear wall 12 to a second, distal end 46. The rear flange 42 generally extends transverse (i.e., normal or slanted) relative to the front wall 36 and the rear wall 12. The rear flange 42 may be parallel to and spaced apart from the top side 28 of the base wall 14 to define a socket 48 extending between the lower retaining lip 32 and the base wall 14, and between the front wall 36 and the second, distal end 46 of the rear flange 42.

The attachment system 10 further includes a release tab 50 extending from a first end 52 disposed at the bottom side 30 of the base wall 14 to a distal second end 54 spaced away from the base wall 14. In particular, the release tab 50 is disposed adjacent to the front edge 26 of the base wall 14. In some implementations, the release tab 50 extends from the first end 52 at the bottom side 30 of the base wall 14 to the distal second end 54 at an acute angle α₅₀ relative to the bottom side 30 of the base wall 14. The release tab 50 may be spaced apart from the front edge 26 of the base wall 14. As shown, the release tab 50 is inwardly offset from the front edge 26 of the base wall 14 such that the release tab 50 is disposed closer to the front edge 26 of the base wall 14 than the rear wall 12 to disengage the lower retaining lip 32. Alternatively, the release tab 50 extends from a front portion 56 of the base wall 14.

With continued reference to FIGS. 1-6, the attachment system 10 further includes an upper retaining lip 58 extending from a first end 60 disposed at the front side 16 of the rear wall 12 to a distal second end 62 spaced away from the front side 16 of the rear wall 12. In some examples, the upper retaining lip 58 extends towards the base wall 14 at an oblique angle α₅₈ from the upper end 20 of the rear wall 12. The upper retaining lip 58 is spaced apart from the top side 28 of the base wall 14 to define a second channel 64 spanning a height H₁₂ of the rear wall 12 along the front side 16 of the rear wall 12. As shown, the second channel 64 generally extends between the upper retaining lip 58 and the top side 28 of the base wall 14. In some implementations, the second channel 64 extends continuously and uninterrupted from the upper retaining lip 58 to the top side 28 of the base wall 14. The first channel 34 and the second channel 64 may cooperate to define a receptacle 66 configured to receive the display device (not shown). Notably, the width W₁₄ of the base wall 14 and the height H₁₂ of the rear wall 12 may be modified (e.g., lengthened or shortened) to accommodate the dimensions of the respective display device received in the receptacle 66.

The attachment system 10 further includes a mounting member 68 attached to the rear wall 12. For example, the mounting member 68 is attached to the rear side 18 of the rear wall 12. The mounting member 68 is generally configured to engage a retail shelf (not shown) such that the attachment system 10 is installed on the front edge of the retail shelf, or other suitable base surface, for displaying the display device.

In operation, the attachment system 10 may be installed (e.g., via the mounting member 68) on a retail shelf at a place of commerce. The attachment system 10 may be inserted onto the retail shelf by a user exerting a force on the mounting member 68 such that the mounting member 68 clicks into place by engagement with the retail shelf. With reference to FIGS. 4A and 4B, the mounting member 68 may be configured to attach the rear wall 12 of the attachment system 10 to the retail shelf at a vertical angle. In particular, when the attachment system 10 is installed, the rear wall 12 may generally be described as extending vertically (i.e., perpendicular) with respect to the ground surface G.

In addition to attaching the attachment system 10 to the retail shelf, the user may install the display device into the receptacle 66. In particular, the display device may be positioned within the receptacle 66 such that an upper edge of the display device engages with the upper retaining lip 58 and a lower edge of the display device engages with the lower retaining lip 32. The upper edge of the display device may engage with the upper retaining lip 58 by sliding into the angle formed between the upper retaining lip 58 and the front side 16 of the rear wall 12, and once the upper edge of the display is engaged, the user may press the lower edge of the display device into the lower retaining lip 32 to exert a force on the base wall 14 such that the lower edge of the display device biases the base wall 14 until the lower edge of the display device is positioned within the socket 48 formed by the lower retaining lip 32 and the base wall 14. The base wall 14 may spring back into position when the lower edge of the display device is positioned within the socket 48 such that the lower retaining lip 32 maintains the lower edge of the display device within the socket 48 during use. To remove the display device from the attachment system 10, the user may exert a force on the release tab 50 to bias the base wall 14 away from the rear wall 12 (i.e., downward toward the ground surface G) to release the lower edge of the display device from the socket 48. Once the lower edge of the display device is released from the socket 48 the upper edge of the display device may be removed from the upper retaining lip 58. While, as shown, the first end 52 of the release tab 50 is disposed closer to the rear wall 12 in a longitudinal direction than the lower retaining lip 32, it should be understood that the release tab 50 may be placed in any position along the base wall 14 that allows the release tab 50 to bias the base wall 14 away from the rear wall 12.

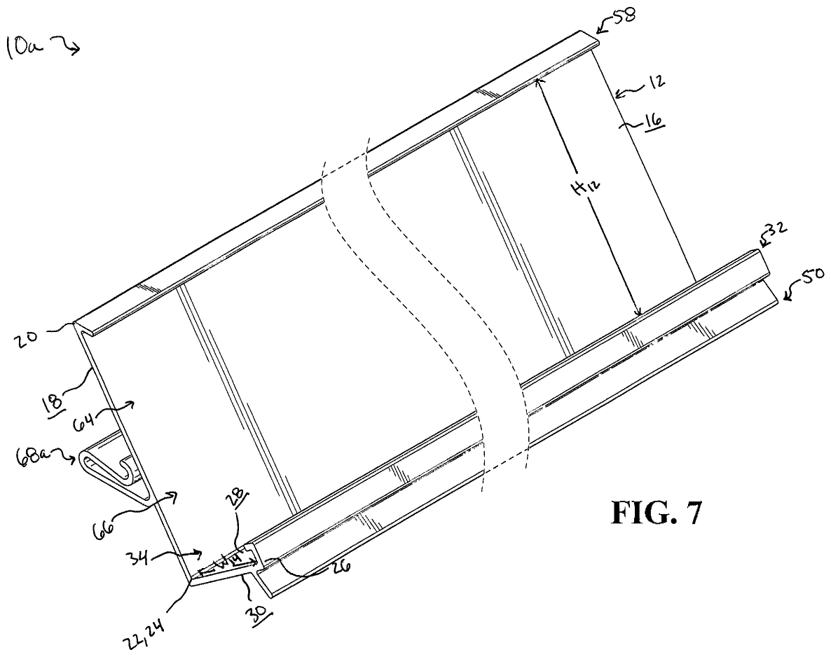

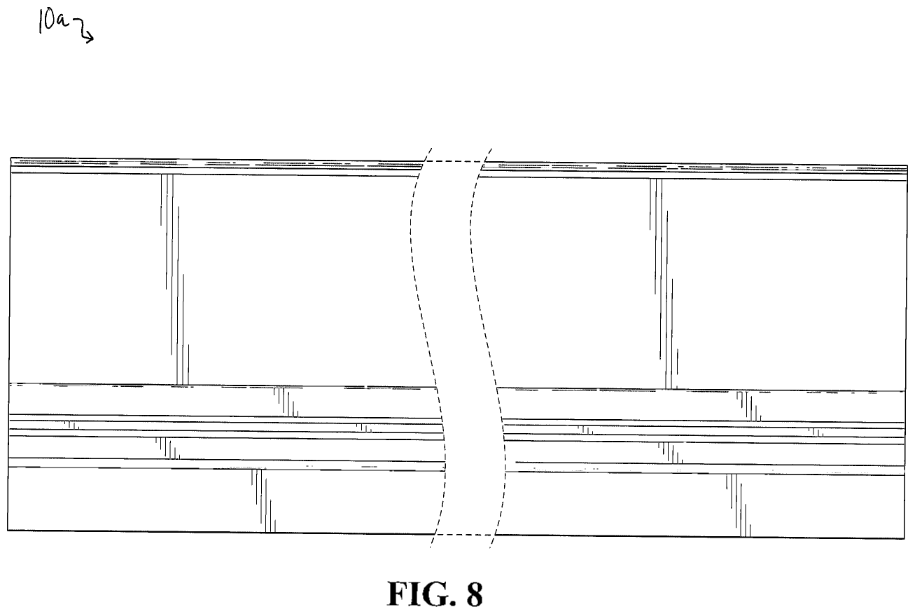

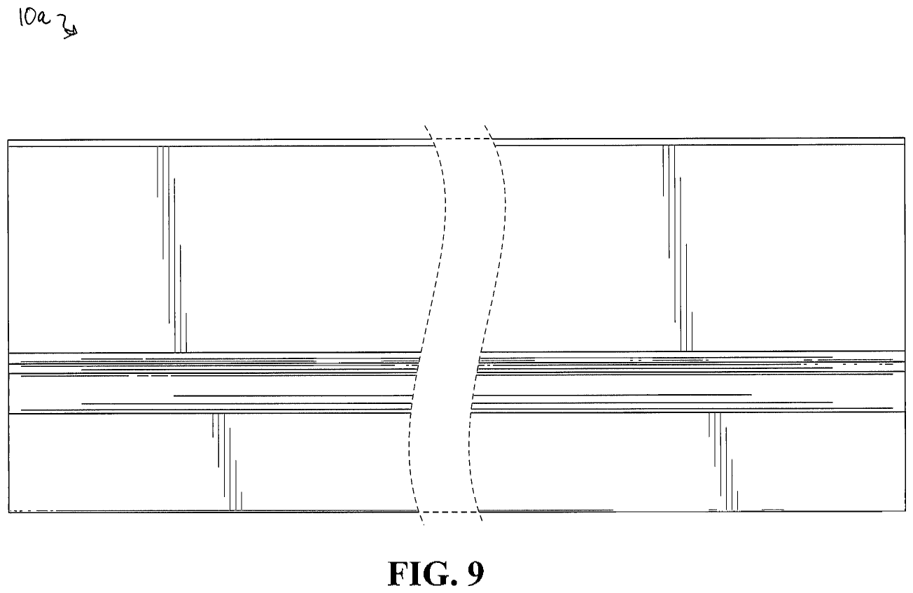

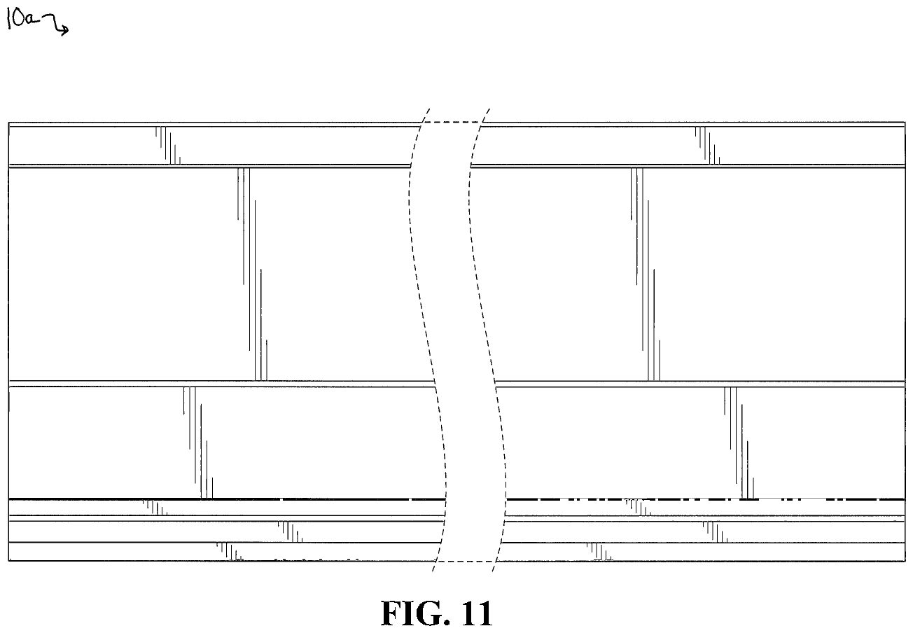

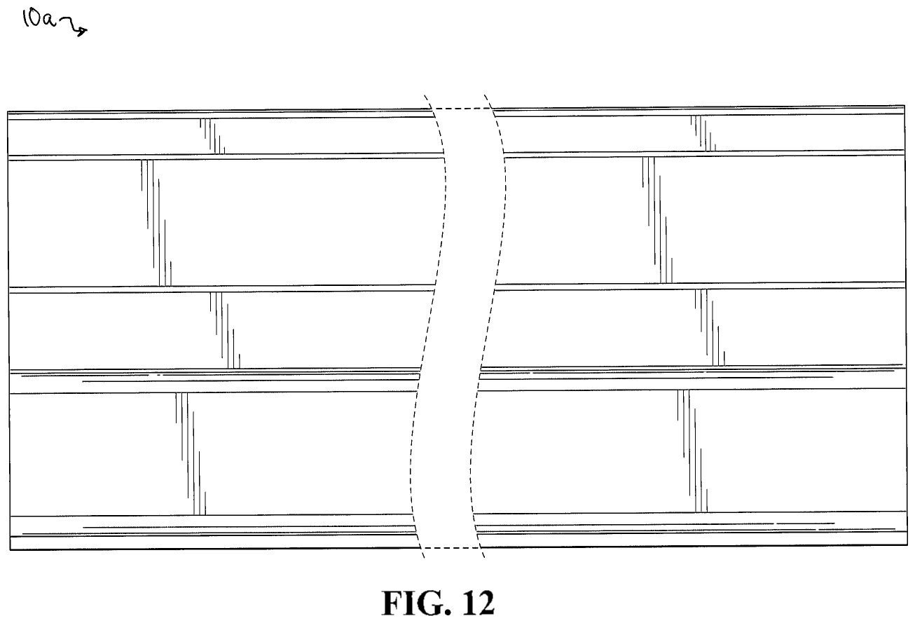

With particular reference to FIGS. 7-12, an attachment system 10a is provided and includes a mounting member 68a attached to a rear wall 12 of the attachment system 10a. In view of the substantial similarity in structure and function of the components associated with the attachment system 10a with respect to the attachment system 10, like reference numerals are used hereinafter and in the drawings to identify like components while like reference numerals containing letter extensions are used to identify those components that have been modified.

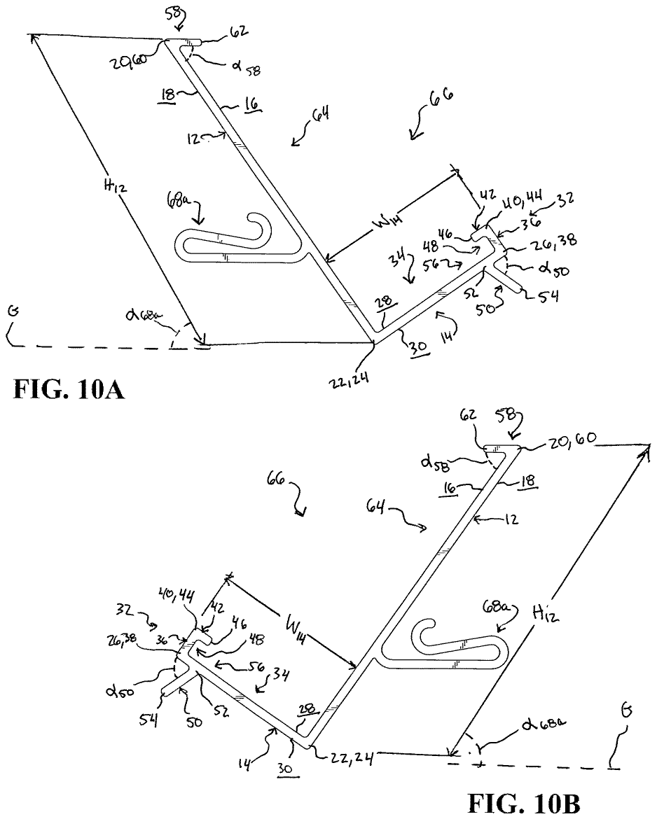

Referring to FIGS. 10A and 10B, the mounting member 68a may be configured to attach the rear wall 12 of the attachment system 10a to a retail shelf at an oblique angle α₆₈ₐ. In particular, the mounting member 68a, when fully installed on the retail shelf, positions the rear wall 12 at the oblique angle α₆₈ₐ relative to the ground surface G. As shown, the oblique angle α₆₈ₐ positions the rear wall 12 of the attachment system 10a such that the front side 16 of the rear wall 12 faces upward and away from the ground surface G for a customer of the retail store to more easily view the display device installed within the attachment system 10a when the attachment system 10a is installed on a retail shelf disposed lower than eye level of customers. In other implementations, the mounting member 68a attaches the rear wall 12 of the attachment system 10a at the oblique angle α₆₈ₐ such that the rear wall 12 faces downward and toward the ground surface G for the customer of the retail store to more easily view the display device is installed within the attachment system 10a when the attachment system 10a is installed on a retail shelf disposed higher than eye level of customers.

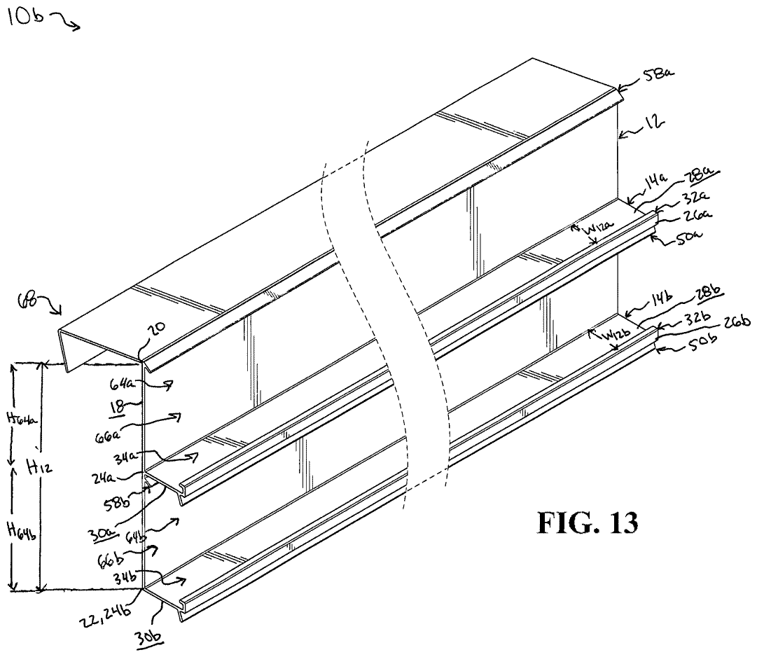

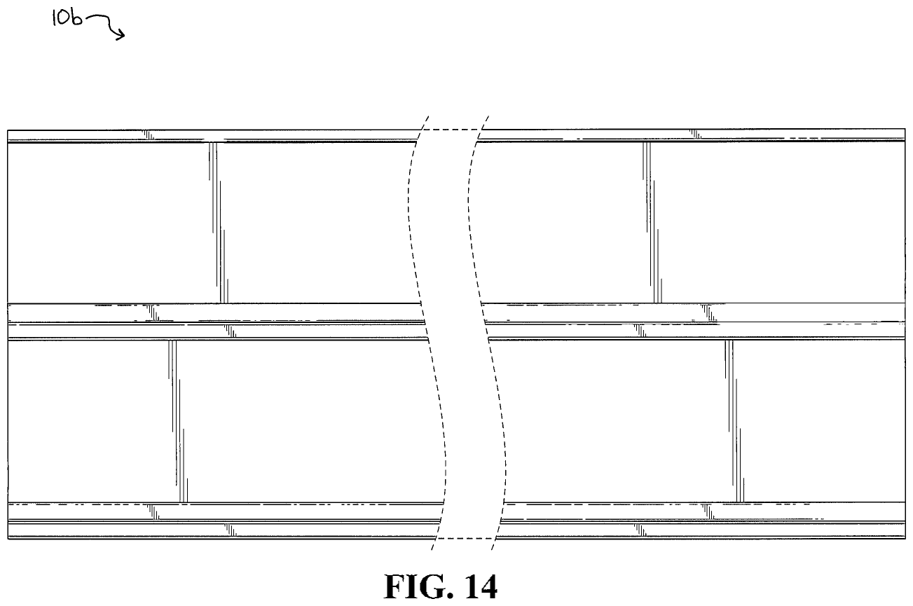

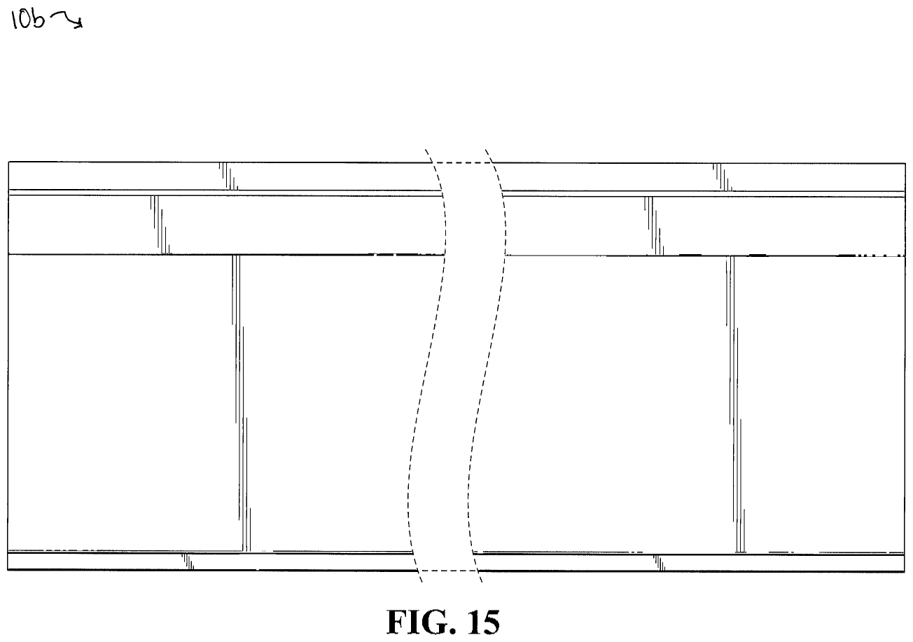

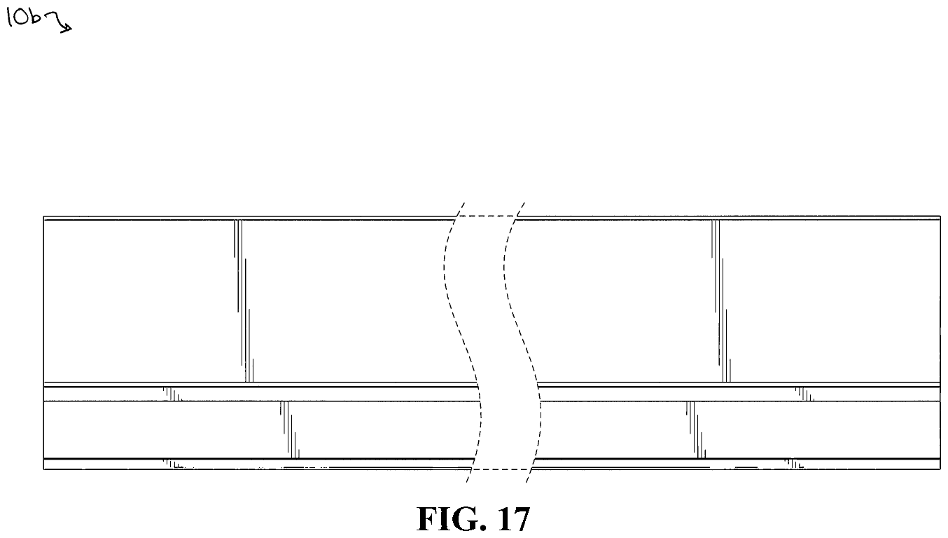

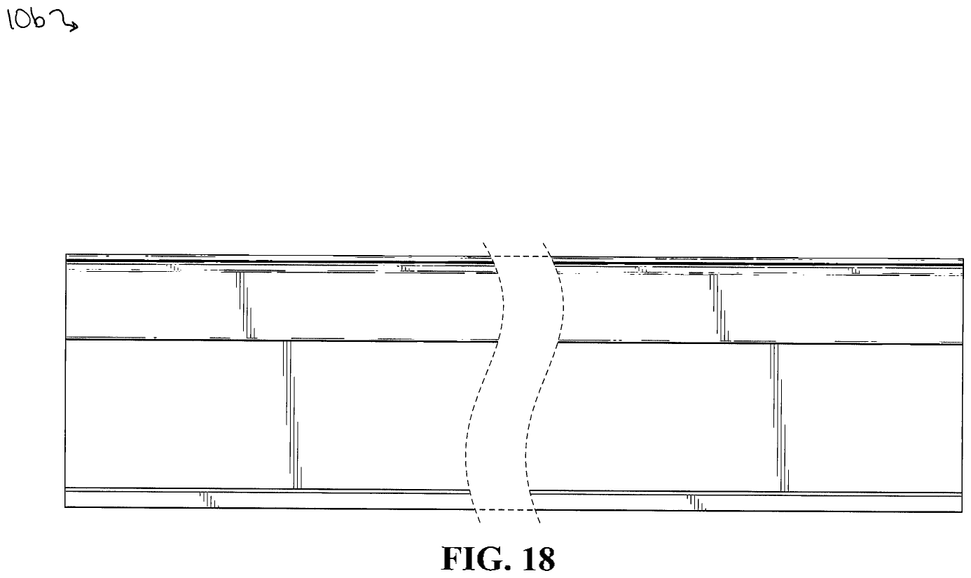

With particular reference to FIGS. 13-18, an attachment system 10b is provided and includes a first base wall 14a and a second base wall 14b each attached to a rear wall 12 of the attachment system 10b. In view of the substantial similarity in structure and function of the components associated with the attachment system 10b with respect to the attachment system 10, like reference numerals are used hereinafter and in the drawings to identify like components while like reference numerals containing letter extensions are used to identify those components that have been modified.

In particular, the attachment system 10b includes a rear wall 12, a first base wall 14a (also referred to as an upper base wall 14a) and a second base wall 14 (also referred to as a lower base wall 14b). As detailed further below, the rear wall 12 and the base walls (14a, 14b) cooperate to form a first receptacle 66a and a second receptacle 66b, such that the attachment system 10b may receive two display devices. Advantageously, the dimensions and placement of the first base wall 14a and the second base wall 14b may be modified, thereby resulting in different sized receptacles 66a, 66b. To this end, the attachment system 10b may be configured to receive two display devices of the same size, or two display devices of different sizes. While the attachment system 10b includes two receptacles 66a, 66b, it should be appreciated that the attachment system 10b may include more than two receptacles 66.

As best shown in FIGS. 4A and 4B, the first base wall 14a extends normal to the rear wall 12 and from a first end 24a disposed at a midpoint (e.g., a position between the upper end 20 and the lower end 22 of the rear wall 12) of the front side 16 of the rear wall 12 to a second, front edge 26a. The first base wall 14a further includes a top side 28a and a bottom side 30a formed on an opposite side of the first base wall 14a from the top side 28a. Similarly, the second base wall 14b extends normal to the rear wall 12 and from a first end 24b disposed adjacent to the lower end 22 of the rear wall 12 and on the front side 16 of the rear wall 12 to a second, front edge 26b. The second base wall 14b further includes a top side 28b and a bottom side 30b formed on an opposite side of the second base wall 14b from the top side 28b. As the first base wall 14a and the second base wall 14b extend normal to the rear wall 12, the base walls 14a, 14b may also generally be defined as extending parallel to one another. In some examples, the base walls 14a, 14b extend from the rear wall 12 at different lengths such that the front edges 26a, 26b are offset from one another in a direction from the rear wall 12 to the front edges 26a, 26b.

The attachment system 10b further includes a first lower retaining lip 32a disposed on the top side 28a of the first base wall 14a and spaced apart from the front side 16 of the rear wall 12 to define an upper first channel 34a extending extends across a width W₁₄ₐ of the first base wall 14a along the top side 28a of the first base wall 14a. The attachment system 10b further includes a second lower retaining lip 32b disposed on the top side 28b of the second base wall 14b and spaced apart from the front side 16 of the rear wall 12 to define a lower first channel 34b extending across a width W_{14b} of the second base wall 14b along the top side 28b of the second base wall 14b. As shown, the first channels 34a, 34b generally extend between the front side 16 of the rear wall 12 and the respective lower retaining lips 32a, 32b disposed on the top sides 28a, 28b of the base walls 14a, 14b. In some implementations, the respective first channels 34a, 34b extend continuously and uninterrupted from the front side 16 of the rear wall 12 to the respective lower retaining lips 32a, 32b. Optionally, the respective first channels 34a, 34b extend continuously from the front side 16 of the rear wall 12 to the respective front edges 26a, 26b of the base wall 14.

Each respective lower retaining lip 32a, 32b includes respective front walls 36a, 36b extending from first ends 38a, 38b disposed at the top sides 28a, 28b of the base walls 14a, 14b to second ends 40a, 40b spaced away from the top sides 28a, 28b of the base walls 14a, 14b. As shown, the respective front walls 36a, 36b extend normal to the respective top sides 28a, 28b of the base walls 14a, 14b, and extend parallel to the rear wall 12. In some implementations the front walls 36 align with and correspond to the front edges 26a, 26b of the base walls 14a, 14b, however in other implementations the front walls 36a, 36b are inwardly offset from the front edges 26a, 26b of the base walls 141, 14b such that the front walls 36a, 36b are disposed closer to the rear wall 12 than the front edges 26a, 26b of the base walls 14a, 14b.

The lower retaining lips 32a, 32b further include respective rear flanges 42a, 42b each extending from respective first ends 44a, 44b disposed at the second ends 40a, 40b of the front walls 36a, 36b towards the rear wall 12 to respective second, distal ends 46a, 46b. The rear flanges 42a, 42b generally extend normal to the front walls 36a, 36b and the rear wall 12. The rear flanges 42a, 42b may be parallel to and spaced apart from the respective top sides 28a, 28b of the respective base walls 14a, 14b to define respective sockets 48a, 48b (i.e., a first socket 48a and a second socket 48b) extending between the lower retaining lips 32a, 32b and the base walls 14a, 14b, and between the front walls 36a, 36b and the second, distal ends 46a, 46b of the rear flanges 42a, 42b.

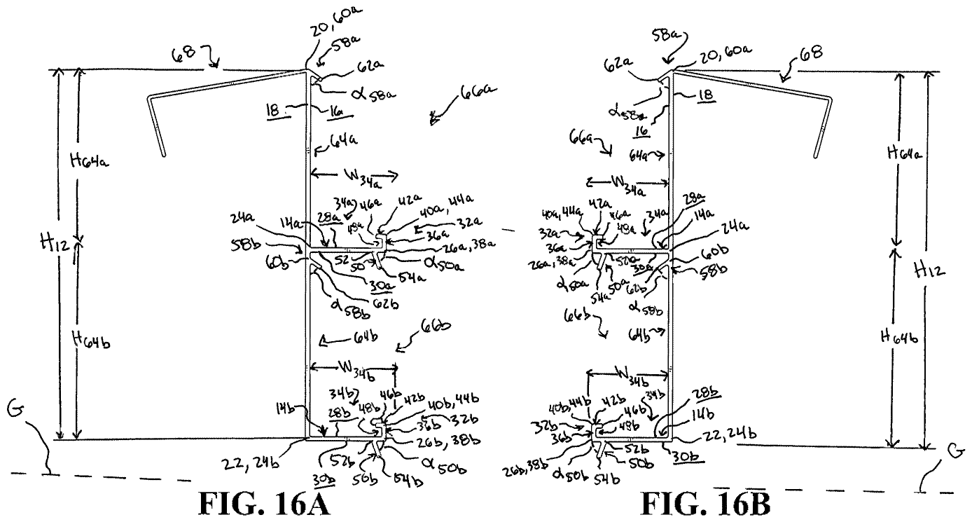

The attachment system 10b further includes respective release tabs 50a, 50b each extending from respective first ends 52a, 52b disposed at the respective bottom sides 30a, 30b of the base walls 14a, 14b to respective distal second ends 54a, 54b spaced away from the base walls 14, 14a, 14b. In particular, the release tabs 50a, 50b are disposed adjacent to the respective front edges 26a, 26b of the base walls 14a, 14b. In some implementations, the release tabs 50a, 50b extend from the respective first ends 52a, 52b at the bottom sides 30a, 30b of the base walls 14a, 14b to the distal second ends 54a, 54b at respective acute angles α₅₀ₐ, α₅₀ₐ relative to the bottom sides 30 a, 30 b of the base walls 14 a, 14 b. While the respective acute angles α₅₀ₐ, α₅₀ₐ shown in FIGS. 16A and 16B are the same, in some implementations, the respective acute angles α₅₀ₐ, α₅₀ₐ may be different from one another.

The release tabs 50a, 50b may be spaced apart from the respective front edges 26a, 26b of the base walls 14a, 14b. As shown, the release tabs 50a, 50b are inwardly offset from the front edges 26a, 26b of the base walls 14a, 14b such that the release tabs 50a, 50b is disposed closer to the rear wall 12 than the front edges 26a, 26b of the base walls 14a, 14b to disengage the lower retaining lips 32a, 32b. Alternatively, the release tabs 50a, 50b extend from respective front portions 56a, 56b of the base walls 14a, 14b. While the release tabs 50a, 50b are shown aligned with one another along their respective base walls 14a, 14b, the release tabs 50a, 50b may be offset from one another along their respective base walls 14a, 14b.

With continued reference to FIGS. 13-18, the attachment system 10b further includes a first upper retaining lip 58a and a second upper retaining lip 58b. Here, each upper retaining lip 58a, 58b extends from respective first ends 60a, 60b disposed at the front side 16 of the rear wall 12 to respective distal second ends 62a, 62b spaced away from the front side 16 of the rear wall 12. In some examples, the upper retaining lips 58a, 58b extend towards the base wall 14 at an oblique angle α₅₈ₐ, α_{58b} from the rear wall 12. While the respective oblique angles α₅₈ₐ, α₅₈ₐ shown in FIGS. 16A and 16B are the same, in some implementations, the respective oblique angles α₅₈ₐ, α₅₈ₐ may be different from one another.

The first upper retaining lip 58a is generally disposed at the upper end 20 of the rear wall 12, while the second upper retaining lip 58b is disposed generally between the upper end 20 of the rear wall 12 and the lower end 22 of the rear wall 12. As shown in FIGS. the second upper retaining lip 58b is disposed closer to the lower end 22 of the rear wall 12 than the second base wall 14b. The respective upper retaining lips 58a, 58b are spaced apart from the respective top sides 28a, 28b of the respective base walls 14a, 14b to define respective second channels 64a, 64b (i.e., upper second channel 64a and lower second channel 64b) each extending along the front side 16 of the rear wall 12. As shown, the second channels 64a, 64b are adjacent to one another and generally extend across a height H₁₂ of the rear wall 12, where the height H₁₂ of the rear wall 12 is divided into the upper second channel 64a and the lower second channel 64b by the second upper retaining lip 58b. In other words, each of the second channels 64a, 64b are defined by the respective upper retaining lips 58a, 58b and the respective top sides 28a, 28b of the respective base walls 14a, 14b. In some implementations, the second channels 64a, 64b extend continuously and uninterrupted from the upper retaining lips 58a, 58b to the top sides 28a, 28b of the base walls 14a, 14b. The upper first channel 34a and the upper second channel 64a may cooperate to define a first receptacle 66a configured to receive a first display device (not shown), while the lower first channel 34b and the lower second channel 64b cooperate to define a second receptacle 66b configured to receive a second display device (not shown). As noted above, the dimensions of the first base wall 14a and the second base wall 14b may be modified, as well as the placement of the base walls 14a, 14b on the rear wall 12, thereby resulting in different sized receptacles 66a, 66b. For example, the widths W₁₄ₐ, W_{14b} of the respective base walls 14a, 14b may be less than the width W₁₄ of the base wall 14. Likewise, the position of the second base wall 14b along the height H12 of the rear wall 12 may be modified to increase or decrease a respective height H₆₄ₐ, H_{64b} of the second channels 64a, 64b. To this end, each receptacle 66a, 66b may have a different dimension such that the attachment system 10b is be configured to receive two display devices of different sizes. Conversely, the receptacles 66a, 66b may have the same dimensions such that the attachment system 10b is configured to receive two display devices of the same size.

The terminology used herein is for describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed herein could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An attachment system for securing a display device to a retail shelf, the attachment system comprising:
a rear wall including a front side and a rear side formed on an opposite side from the front side;
a base wall extending from the front side of the rear wall to a front edge and including a top side and a bottom side formed on an opposite side from the top side;
a lower retaining lip disposed on the top side of the base wall and spaced apart from the front side to define a first channel extending along the top side of the base wall; and
an upper retaining lip extending from the front side of the rear wall at an oblique angle and spaced apart from the top side of the base wall to define a second channel extending along the front side of the rear wall.

2. The attachment system of claim 1, wherein the upper retaining lip extends along the oblique angle from a proximal end attached to the front side of the rear wall to a distal end spaced apart from the proximal end.

3. The attachment system of claim 1, wherein the base wall extends from the front side of the rear wall to the front edge by a first distance, and the distal end of the upper retaining lip is spaced from the front side of the rear wall by a second distance, the first distance being greater than the second distance.

4. The attachment system of claim 1, wherein the first channel extends continuously and uninterrupted from the front side of the rear wall to the lower retaining lip.

5. The attachment system of claim 1, further comprising a mounting member attached to the rear side of the rear wall and configured to attach the rear wall to the retail shelf.

6. The attachment system of claim 5, wherein the mounting member is configured to position the rear wall at an oblique angle relative to a ground surface.

7. The attachment system of claim 1, wherein the base wall is substantially perpendicular to the rear wall.

8. The attachment system of claim 1, further comprising a socket formed between the lower retaining lip and the base wall, wherein the socket includes an opening facing the rear wall.

9. The attachment system of claim 8, wherein the lower retaining lip includes a front wall extending from the top side of the base wall and a rear flange extending from the front wall towards the rear wall.

10. The attachment system of claim 9, wherein the rear flange is spaced apart from the top side of the base wall to define the socket between the lower retaining lip and the rear flange.

11. An attachment system for securing a display device to a retail shelf, the attachment system comprising:
a rear wall including a front side and a rear side formed on an opposite side from the front side;
a base wall extending from the front side of the rear wall to a front edge and including a top side and a bottom side formed on an opposite side from the top side;
a lower retaining lip disposed on the top side of the base wall and spaced apart from the front side to define a first channel extending along the top side of the base wall, the lower retaining lip defining a socket between the lower retaining lip and the base wall; and
an upper retaining lip extending from the front side of the rear wall at an oblique angle and spaced apart from the top side of the base wall to define a second channel extending along the front side of the rear wall.

12. The attachment system of claim 11, wherein the upper retaining lip extends along an oblique angle from a proximal end attached to the front side of the rear wall to a distal end spaced apart from the proximal end.

13. The attachment system of claim 11, wherein the base wall extends from the front side of the rear wall to the front edge by a first distance, and the distal end of the upper retaining lip is spaced from the front side of the rear wall by a second distance, the first distance being greater than the second distance.

14. The attachment system of claim 11, wherein the first channel extends continuously and uninterrupted from the front side of the rear wall to the lower retaining lip.

15. The attachment system of claim 11, further comprising a mounting member attached to the rear side of the rear wall and configured to attach the rear wall to the retail shelf.

16. The attachment system of claim 15, wherein the mounting member is configured to position the rear wall at an oblique angle relative to a ground surface.

17. The attachment system of claim 11, wherein the base wall is substantially perpendicular to the rear wall.

18. The attachment system of claim 11, wherein the socket includes an opening facing the rear wall.

19. The attachment system of claim 18, wherein the lower retaining lip includes a front wall extending from the top side of the base wall and a rear flange extending from the front wall towards the rear wall.

20. The attachment system of claim 19, wherein the rear flange is spaced apart from the top side of the base wall to define the socket between the lower retaining lip and the rear flange.
